(19) United States
(12) Patent Application Publication
(10) Pub. No.: US 2022/0292519 A1
(43) Pub. Date: Sep. 15, 2022

(54) ITEM RETURN DATA INTEGRATION PROCESSING

(71) Applicant: NCR Corporation, Atlanta, GA (US)

(72) Inventor: Matthew Robert Burris, Atlanta, GA (US)

(21) Appl. No.: 17/201,203

(22) Filed: Mar. 15, 2021

(51) Int. Cl. G06Q 30/00; G06Q 20/20; G06Q 30/02; G06Q 20/40; G06F 16/9537

(52) U.S. Cl. CPC G06Q 30/012; G06Q 20/202; G06Q 30/0282; G06Q 20/407; G06Q 30/0203; G06F 16/9537

(57) ABSTRACT

An item return is identified at a transaction terminal and a real-time notification is provided to a cloud-based item return service. The service obtains contact information for a consumer associated with the item return along with item return data being collected at the transaction terminal. The service provides the item return data in near-real time to a manufacturer/supplier of an item associated with the item return. A communication directed by the manufacturer/supplier is provided by the service to the consumer using the contact information for collection of additional information relevant to the item return. The item return data and any additional information collected from the consumer are indexed and housed in a data store by the service for subsequent customized searching, mining, and reporting by the manufacturer/supplier for correlations associated with item returns.

### BACKGROUND

Annually, consumers return merchandise in significant numbers. Retailers rarely retain useful information about why a given consumer is returning an item. Moreover, the manufacturers/suppliers of the merchandise often do not receive whatever information the retailers do acquire from the consumers during the returns.

Moreover, retailers do not alert the manufacturers in real time to item returns; rather, the only information the manufacturers obtain is an invoice from the retailers indicating the items that were returned and the money due from the manufacturer for the returned merchandise.

The returns' invoices are not processed on the same day of the returns, instead the invoices are batched together by the retailers and processed with the manufacturers on a weekly, monthly, or quarterly basis. Manufacturers have to forecast what expected returns are going to be during planning and are unable to quickly identify problems to stem and to control the item return rates.

As a result, manufacturers have no effective mechanism to identify whether items are being returned because of issues arising with their distributors, their shippers, their retailers, their own manufacturing processes, or simply dislikes of the consumers themselves.

In short, item returns are a black box from the perspective of the manufactures/suppliers with little to no timely and valuable data about the returns being available for the manufacturers to make quality proactive decisions, which would improve product/item development, improve business planning, and identify quality retailers, shippers, and distributors for partnerships.

### SUMMARY

In various embodiments, methods a system for item return data integration processing are presented.

According to an embodiment, a method for item return data integration processing is presented. A notification of an item return being processed on a transaction terminal for an item is received. Retailer-specific data, consumer-specific data, item specific data, and item return data are obtained from a retailer associated with the item return. A manufacturer and retailer workflow associated with the retailer and a manufacturer of the item is identified. The workflow is processed to provide a near real-time alert to the manufacture.

### BRIEF DESCRIPTION OF THE DRAWINGS

FIG. 1 is a diagram of a system for item return data integration processing, according to an example embodiment.

FIG. 2 is a diagram of a method for item return data integration processing, according to an example embodiment.

FIG. 3 is a diagram of another method for item return data integration processing, according to an example embodiment.

### DETAILED DESCRIPTION

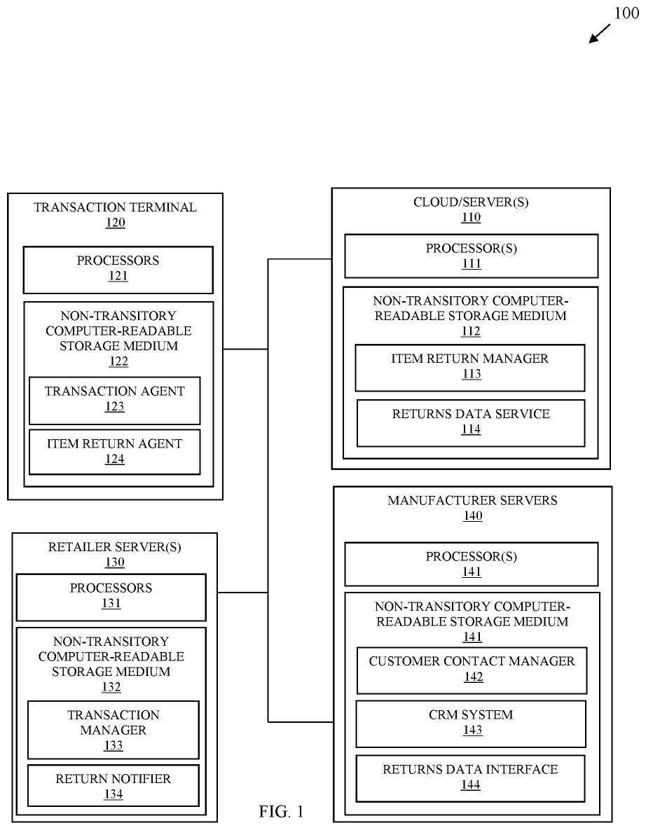

FIG. 1 is a diagram of a system for item return data integration processing, according to an example embodiment. It is to be noted that the components are shown schematically in greatly simplified form, with only those components relevant to understanding of the embodiments being illustrated.

Furthermore, the various components (that are identified in architecture 100) are illustrated and the arrangement of the components are presented for purposes of illustration only. It is to be noted that other arrangements with more or less components are possible without departing from the teachings of item return data integration processing, presented herein and below.

System 100 provides techniques by which manufacturers/suppliers/distributors can obtain valuable item return data from retailers who sell their products/items. Moreover, near real-time notifications of returns are provided to the manufacturers as item returns are processed on transaction terminals by or on behalf of consumers. Retailer data associated with the consumer, segments of consumers, and/or a given item is augmented with item return data associated with item returns. When authorized by the retailers, customized manufacturer surveys are sent to the consumers for obtaining additional information with respect to the item returns. Any surveys provided do not disclose consumer identifying information to the manufacturers. The additional information, item return data, and retailer data are indexed, linked together, and stored in a data store. A manufacturer-provided interface to the data store is provided for searching and mining the data store for purposes deriving correlations for item returns. System 100 provides a mechanism by which manufacturers can proactively participate in item returns for making better decisions that decrease item return rates of their products/items.

As used herein and below, the term “operator” refers to a customer or retail staff interacting with interfaces of a device. A “device” refers to any device processing the interfaces for which an operator interacts with during an item return.

The terms “staff,” “staff member,” “user,” “customer,” “consumer,” “personnel,” “actor,” “person,” “individual,” and “clerk” may be used interchangeably and synonymously with the term “operator.”

The term “item” may be used interchangeably and synonymously with the terms “product” and/or “good.”

A “transaction terminal 120” is a type of device that is used to perform transactions (purchases and returns), which may also include a variety of integrated peripheral devices or which may be interfaced to peripheral devices. The peripheral devices may comprise card readers, currency/coin acceptors and dispensers, scanners, weigh scales, integrated scanners with weigh scales, touch displays, cameras, etc.

A consumer device may also be considered a transaction terminal 120 when the consumer device is being operated by a consumer for purposes of performing an item return, such that in some embodiments, the transaction terminal 120 is a phone, a laptop, a desktop, a tablet, a voice-based network-enabled device (Google® Home®, Amazon® Echo®, etc.), etc.

A staff operated device can also be a transaction terminal 120 when a staff member operates the device for purposes of performing an item return on behalf of a customer. The staff operated device may be a Point-Of-Sale (POS) terminal, a tablet, a phone, a laptop, or a desktop.

In some cases, a consumer performs a self-item return via a transaction terminal 120 located within a retail store, such that in these situations the transaction terminal 120 is a Self-Service Terminal (SST) or a kiosk.

As used herein the term “manufacturer” is used to identify an entity that manufactures an item/product that is the subject of a return. It is noted that a supplier and a distributor of the item/product may also benefit from the teachings and embodiments discussed herein, such that use of the term manufacturer is intended to also apply equally to a supplier or a distributor associated with the item/product. That is, the features and functions that inure to a manufacturer discussed herein are also intended to be equally available to a supplier and a distributor of a corresponding item/product being returned by a consumer.

System 100 comprises a cloud/server 110, a transaction terminal 120, retailer servers 130, and manufacturer/supplier/distributor servers 140.

Cloud/Server 110 comprises at least one processor 111 and a non-transitory computer-readable storage medium 112. Medium 112 comprises executable instructions for item return manager 113 and returns data service 114. The executable instructions when provided to processor 111 from medium 112 cause processor 111 to perform the processing described herein and below with respect to 113-114.

Transaction terminal 120 comprises at least one processor 121 and a non-transitory computer-readable storage medium 122. Medium 122 comprises executable instructions for transaction agent 123 and item return agent 124. The executable instructions when provided to processor 121 cause processor 121 to perform the processing described herein and below with respect to 123-124.

Each retailer server 130 comprises one or more processors 131 and non-transitory computer-readable storage medium 132. Medium 132 comprises executable instructions for transaction manager 133 and return notifier 134. The executable instructions when provided to one or more processors 131 from medium 132 cause processors 131 to perform the processing described herein and below with respect to 133-134.

Each manufacturer server 140 comprises one or more processors 141 and non-transitory computer-readable storage medium 142. Medium 142 comprises executable instructions for customer contact manager 142, Customer Relationship Management (CRM) system 143, and returns data interface 144. The executable instructions when provided to one or more processors 141 from medium 142 cause processors 141 to perform the processing described herein and below with respect to 142-144.

Terminal 120 performs transactions for selling items and performing item returns. Transaction agent 123 processes a workflow that interacts with transaction manager 133 for purposes of completing a transaction to sell an item to a consumer on behalf of a retailer at a retailer store or online (via a web-based or app-based interface). Item return agent 124 processes a workflow that interacts with transaction manager 133 for purposes of completing a return (item return) transaction associated with a previous item purchased by a consumer on behalf of a retailer at a retailer store or online (via a web-based or app-based interface).

Transaction manager 133 processes both item purchase transaction workflows and item return transaction workflows through interaction with transaction agent 123 and item return agent 124. The item return workflow is enhanced and modified with the teachings presented herein, such that during an item return transaction, transaction manager 133 notifies return notifier 134 of the item return along with item return data gathered by item return agent 124, transaction manager 133, and return notifier 134 from a retailer's transaction, product/item catalogue, and customer loyalty data stores.

Item return data may comprise, a customer identifier for the customer associated with the item return, a customer profile associated with the customer identifier, an item code for the item, item pricing, item category, item description, original transaction identifier for the original purchase transaction of the item by the customer (if available), a terminal identifier for the terminal 120, a store identifier for the store associated with the item return, geographical location data for the store, a purchase transaction store identifier for the store associated with the original item purchase (if available), planogram data for shelf location of the item within the store, sales data for the item code associated with the item, geographical data for the store associated with the original purchase transaction, a retailer identifier for the retailer, a transaction history for the customer, customer demographic data or customer segmentation data for the customer maintained in the loyalty data store, a supplier identifier for a supplier of the item being returned, a distributor identifier for a distributor of the item being returned, a manufacturer identifier for a manufacturer of the item being returned, calendar date for the item return, day of the week for the item return, time of day for the item return, an item return reason code that identifies a selected reason why the customer is returning the item (if available through item return agent 124 and/or transaction manager 133), and the and weather data for current climate data associated with a geographical location of terminal 120 (note this may be obtained by return notifier using an Application Programming Interface (API) call to a web-based weather service along with a zip code assigned to the geographical location of terminal 120—note also that terminal 120 may be a mobile device operated by the consumer, such that the mobile device reports through item return agent 124 a current geographical location of the mobile device using the device's location services.

It is to be noted that the item return data may comprise additional information available to retailer from their data stores from what was presented above or less information from what was presented above.

Also, customer profile data of the item return data may comprise customer contact information (such as mobile device number, email address, social media identifiers, etc.), customer name, customer loyalty level, preferred contact channel of customer (e.g., via email, text, and/or voice call).

Return notifier 134 sends an item return transaction identifier for the item return in real time along with the item return data to item return manager 113 of cloud 110 as the item return is being processed on terminal 120.

Item return manager 113 indexes, links, and stores the item return data in an item return data store based on the retailer identifier for the retailer, the manufacturer identifier for the manufacture, the item identifier for the returned item, a customer identifier for the customer, and the item return transaction identifier.

Item return manager 113 then obtains a workflow associated with the manufacturer and the retailer for the item return and initiates processing of the workflow. The workflow is customized for the manufacturer and the retailer and provides processing actions that permits the manufacturer with prior-obtained retailer approval to engage the customer directly to obtain additional information regarding a reason for the item return (even if the reason code was collected in item return data by the item return agent 124 and/or transaction manager 133). The manufacturer and retailer workflow causes item return manager 113 to provide selective item return data to customer contact manager 142. That is, the customer name and contact information may not be authorized by the retailer for the manufacturer to see, such that customer identifying information is not visible to customer contact manager 142.

Customer contact manager 142 may, in response to receiving the selective item return data for the item return, provided back to item return manager 113 a link to a survey or questionnaire developed by the manufacturer and authorized for use with the customers of the retailer in the manufacturer and retailer workflow. This authorization may be evidenced by a certificate or a signature on the link, which item return manager 113 verifies. The link to the survey or questionnaire once verified is sent to the customer by item return manager 113 using the customer's contact information to a customer-operated device. The customer provides responses after activating the link, which are recorded by customer contact manager 142 and/or by item return manager 113.

The manufacturer and retailer workflow may authorize direct contact between the customer of the retailer and a representative of the manufacture, such that a customer contact mobile phone number is provided by item return manager 113 to customer contact manager 142. In this instance the representative of the manufacturer may initiate a voice call directly with the customer in near real time following the item return at terminal 120.

In some case, the link sent to the customer may establish a voice and/or video conference between the customer's device and a representative of the manufacturer when the customer activates the link.

In some cases, the link sent to the customer may establish a voice and/or video conference between terminal 120 (via modifications to an item return workflow processed by item return agent 124) and a device of the representative for the manufacturer.

The manufacturer and retailer workflow may also provide promotions or enticements through CRM system 143, which customer contact manager 142 provides as links to item return manager 113. Item return manager delivers the promotions or enticements with the questionnaire, survey, and/or link to activate a voice call or a video conference.

Any additional information collected from the customer through a completed questionnaire or a completed survey may be automatically indexed and stored in the item return data store by item return manager 113.

Any representative-supplied additional information collected from the customer through a completed voice call or a completed video conference may be provided by the representative to item return manager 113 through returns data interface 144 following or during the voice call/video conference. Again, this representative-supplied additional information is indexed in stored in the item return data store by item return manager 113.

Returns data interface 144 provides a manufacturer representative interface for querying, mining, and obtaining customized reports from returns data service 114. Returns data service 114 provides a backend interface to the item return data store maintained by cloud 110. The querying, mining, and reporting may also be achieved by automated applications of the manufacturer server 140 through an API to returns data service 114.

A manufacturer may establish multiple different workflows for its different retailers with item return manager 113. Such that, the additional data collection and interactions with a given customer for a given item return at a given retailer is customized and authorized by the given retailer. Additionally, item return manager 113 manages and processes workflows for multiple retailers of multiple items. Furthermore, the type of contacts with the customer and the type of additional information collected from the customer can be customized through the workflows or links provided during the processing of a workflow by each manufacturer's customer contact manager 142.

An example item return transaction is now discussed for illustration with the above-noted teachings as context and in view of FIG. 1 and system 100.

A consumer initiates a return (item return transaction) on a mobile device of the consumer or an in-store terminal. The device representing transaction terminal 120.

As the consumer interacts with item return agent on terminal 120 through a user-facing interface, each item being returned is identified (through scan or entered item code), the customer identity or customer identifier is determined, and a return rationale (item return code) can be captured.

Item return agent 124 interacts with transaction manager 133 to process the return transaction. Manager 133 notifies return notifier 134 that the transaction being processed is an item return transaction.

Item return agent 124 gathers retail-specific data from retail data stores based on at least the customer identifier and the item code(s) associated with the item(s) being returned in the item return transaction. The retail-specific data may include consumer demographics data associated with the consumer performing the return, geographic location data for a location of terminal 120 (note this may be the consumer's device or an instore device), the consumer's purchase or transaction history, and current weather and climate data at the geographic location of terminal 120 (such as through an API to a web-based weather service). The data may be further combined with other data of the retailer from the retailer's data store, such as sales data associated with the item code(s), produce catalogue data for the item code(s), planogram data for the item code(s) (shelf location within the store), and other retailer-specific data.

The item return transaction information and other additional gathered retailer-specific information is provided from return notifier 134 to item return manager 113. The information is indexed, linked, and stored in the cloud-based item return data store by item return manager 113. This allows for subsequent mining of the item return data store to identify correlations between the item return and the retailer's merchandising factors that can influence an item's sales, shelf position, future stock (inventory) levels, indications as to whether a shipper or a distributor will continue to be used by the retailer for the item(s), and/or whether lock pick, pack, or delivery performed poorly and contributed to the item return transaction.

Item return manager 113 then retrieves a manufacturer and retailer workflow for the item being returned and processes the workflow for purposes of notifying customer contact manager 142 in near real-time of the item return transaction and the item(s) associated with the return and for purposes of provided selective information authorized by the workflow to the manufacturer.

If the workflow permits surveys and the item return and related data gathered from the retailer match criteria for a given survey (as defined in the workflow (e.g., age of return (how long since the item was originally purchased by the consumer), item return reason code, consumer demographics, a minimum number of consumers has not been reached for the given survey, etc.), then item return manager verifies that the given survey is authorized or permitted by the retailer to protect the consumer experience level expected by the retailer (this can be through evaluation of criteria defined by the retailer within the workflow or can be a pre-authorized survey comprising a certificate or a digital signature of the retailer that item return manager 113 can verify/validate as authentic).

An authorized survey is then provided to the consumer along with any authorized consumer compensation or rewards (promotions) for agreeing to participate in the survey. The compensation can be in various forms and provided through the retailer and/or the manufacturer (via CRM system 143) as defined in the workflow, such as manufacturer/supplier coupons, retailer gift certificates, retailer loyalty points, entry into a context or a drawing for a prize, etc.

Assuming the consumer agrees to participate in the survey, results may be maintained by item return manager 113 on behalf of both the retailer and the manufacturer and indexed, linked, and stored in the item return data store.

It is to be noted that at no time does the manufacturer, supplier, or distributor gain or obtain direct access to communicate with the customer unless the manufacturer and retailer workflow provides such access through voice calls or video conferencing between a representative of the manufacturer and the consumer (as was discussed above).

Over time valuable item return information is housed in the item return data store maintained by cloud 110. A manufacturer may mine, query, and obtain reports via returns data interface 144 and returns data service 114. In some cases, automated applications of the manufacturer may directly interact with returns data service 114 for access to the item return data store through API calls for automated mining and reporting. The mining operations may process item data and retailer data for any given item code, set of item codes, retailer, set of retailers for purposes of discovering correlations related to merchandising factors that may be impacting item return rates, such that the manufacturer can work with the retailer to decrease the item return rates by adjusting the merchandising factors.

In an embodiment, the item return is pre-staged via a mobile or user-owned and controlled device (laptop, desktop, phone, wearable processing device, etc.). Subsequent to the pre-staging, the consumer goes to a store of the retailer and accesses an SST for a self-item return that was pre-staged via the consumer's device for completing the item return on the SST. It may also be that the instore terminal 120 is a POS terminal operated by staff of the retailer to complete the pre-staged item return on behalf of the consumer. In this embodiment, there may be two transaction terminals 120 (the pre-staged consumer operated device and the instore terminal where the pre-staged item return is completed). During the pre-stage workflow, the item return agent 124 interacts with transaction manager 133 and provides the notification to item return manager 113 that the item return is being pre-staged and will be completed later within a store of the retailer. This presents a unique opportunity to both the retailer and the manufacturer to reach out to the consumer before the instore visit to complete the item return for purposes of changing the mind of the consumer by offering a partial refund, a promotion, a replacement item, a different item that is similar to the item being returned, or some other incentive. Item return manager 113 can maintain a return type to identify when an item return is in pre-staging workflow, is associated with an instore workflow that is following an initial pre-staging workflow, or is a normal retailer-based item return workflow (the item is being returned either via a consumer device or an instore retailer device). The manufacturer and retailer workflow can account for the type of item return and provide customized sub-workflows that are processed by item return manager 112 based on the type.

In an embodiment, cloud 110 includes authentication services, bundling services, integration services, reporting services, and mining services for using the data comprised in the item return data store. Here, cloud 110 acts as an intermediary and/or gatekeeper to the item return data and provides a variety of services to both the manufacture and the retailer for accessing, mining, reporting, and integrating the item return data into systems of the retailer and manufacturer. For example, trained machine-learning algorithms may be trained on item return data, retailer-specific data, promotions provided to the consumer, and types of interactions with the consumer along with results observed from the consumer (such as a subsequent purchase of a similar item, retraction of the item return, decrease in frequency of item returns) for completed item returns. The machine-learning algorithm then provides as output a predicted result for any given item return and a proposed workflow interaction with the consumer. These predictions and suggested alternative workflow interactions may be provided as a value-added service to both the retailer and the manufacturer during any given return with interaction between item return manager 113 and customer contact manager 142 (return notifier 134 for the retailer). This is but one example, of value-added services that can extend the functionality discussed herein with respect to cloud 110 vis-a-vis the retailer servers 130 and the manufacturer servers 140.

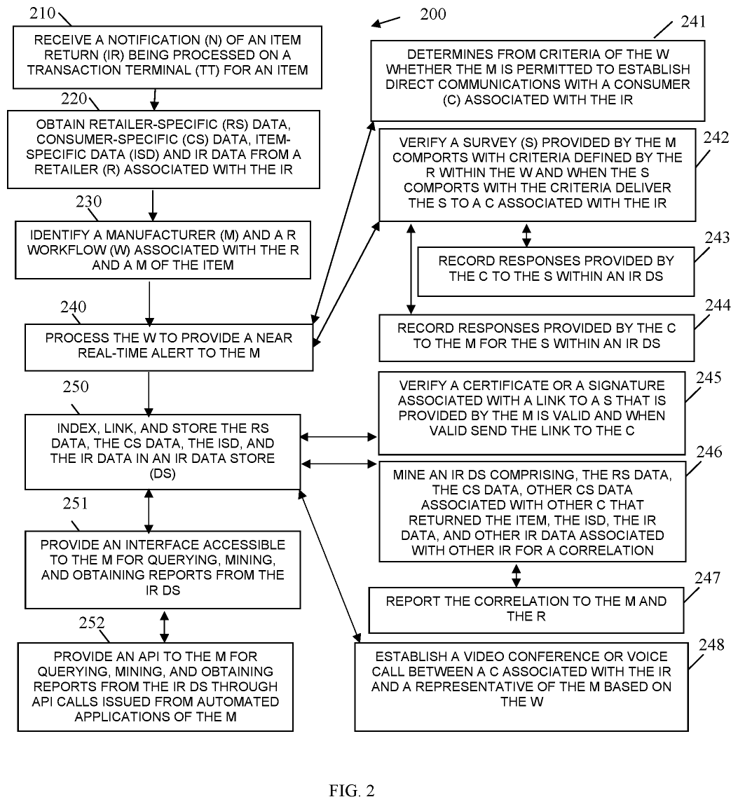

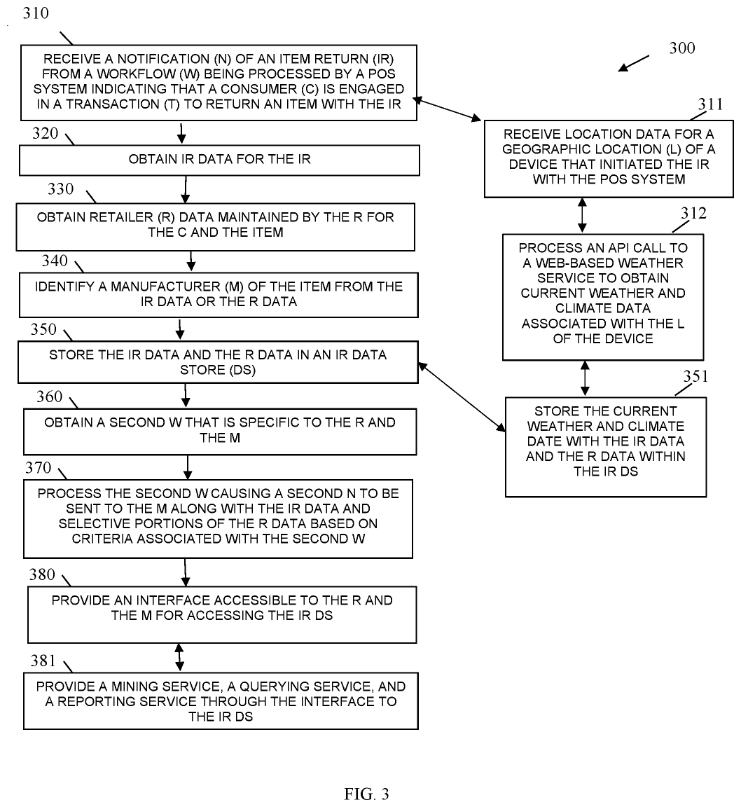

These and other embodiments are now discussed with reference to FIGS. 2-3.

FIG. 2 is a diagram of a method 200 for item return data integration processing, according to an example embodiment. The software module(s) that implements the method 200 is referred to as an “item return integration manager.” The item return integration manager is implemented as executable instructions programmed and residing within memory and/or a non-transitory computer-readable (processor-readable) storage medium and executed by one or more processors of one or more devices. The processor(s) of the device that executes the item return integration manager are specifically configured and programmed to process the item return integration manager. The item return integration manager may have access to one or more network connections during its processing. The network connections can be wired, wireless, or a combination of wired and wireless.

In an embodiment, the device that executes the item return integration manager is server 110. In an embodiment, server 110 is a cloud-based server comprised of a plurality of servers logically cooperating and accessible as a single server 110 (cloud 110).

In an embodiment, the item return integration manager is all or some combination of 113-114.

At 210, the item return integration manager receives a notification of an item return being processed on a transaction terminal from an item. The transaction terminal can be a consumer-owned device (desktop or mobile device) having an application or a web-based interface for performing self item returns with a POS system of the retailer. The transaction terminal may also be an SST located within a store of the retailer where the consumer is performing a self item return. Alternatively, the transaction terminal can be a mobile device of a POS terminal operated by a staff member of the retailer who is performing the item return on behalf of the consumer with the POS system of the retailer.

At 220, the item return integration manager obtains retailer-specific data, consumer-specific data, item-specific data, and item return data from a retailer associated with the item return. These data can be any of the data referenced above with the discussion of system 100 (discussed as item return data with portions that are specific to the item, the consumer, and the retailer).

At 230, the item return integration manager identifies a manufacturer and retailer workflow associated with the retailer and a manufacturer/distributor/supplier of the item being returned in the item return.

At 240, the item return integration manager processes the workflow to provide a near real-time alert to the manufacturer. Near real-time is intended to mean before the consumer completes the item return on the transaction terminal or shortly after the item return completes with the POS system of the retailer.

In an embodiment, at 241, the item return integration manager determines from criteria of the workflow whether the manufacturer is permitted to establish direct communications with a consumer associated with the item return.

In an embodiment, at 242, the item return integration manager verifies a survey or questionnaire provided by a manufacturer comports with criteria defined by the retailer within the workflow and when the survey comports with the criteria, the item return integration manager delivers the survey/questionnaire to a consumer associated with the item return.

In an embodiment of 242 and at 243, the item return integration manager records responses provided by the consumer to the survey/questionnaire within an item return data store maintained by the item return integration manager.

In an embodiment of 242 and at 244, the item return integration manager records responses provided by the consumer to the manufacturer for the survey/questionnaire within an item return data store maintained by the item return integration manager. Here, the item return integration manager does not receive the consumer responses directly rather the responses are received by the manufacturer and provided back to the item return integration manager through interface 144.

In an embodiment, at 245, the item return integration manager verifies a certificate or a signature associated with a link to a survey/questionnaire that is provided by the manufacturer is valid and when valid, the item return integration manager sends the link to the consumer.

In an embodiment, at 246, the item return integration manager mines an item return data store that comprises the retailer-specific data, the consumer-specific data, other consumer-specific data associated with other consumers that returned the item, the item-specific data, the item return data, and other item return data associated with other item returns for at least one correlation between portions of the data and the item returns.

In an embodiment of 246 and at 247, the item return integration manager reports the correlation(s) to the manufacturer and the retailer.

In an embodiment, at 248, the item return integration manager establishes a video conference or voice call between a consumer associated with the item return and a representative of the manufacturer based on the workflow and criteria associated with the workflow (such as confirmed retailer authorization for the video conference by the representative of the manufacturer).

In an embodiment, at 250, the item return integration manager indexes, links, and stores the retailer-specific data, the consumer-specific data, the item specific data, and the item return data in an item return data store maintained by the item return integration manager.

In an embodiment of 250 and at 251, the item return integration manager provides an interface 144 that is accessible to the manufacturer for querying, mining, and obtaining reports from the item return data store.

In an embodiment of 251 and at 252, the item return integration manager provides an API to the manufacturer for querying, mining, and obtaining reports from the item return data store through API calls issued from automated applications of the manufacturer. These applications can be embedded in customized workflows of the manufacturer and or initiated based on detection of events or conditions for purposes of evaluating, reporting, and analyzing item returns associated with items of the manufacturer.

FIG. 3 is a diagram of another method 300 for item return data integration processing, according to an example embodiment. The software module(s) that implements the method 300 is referred to as an “item return transaction integration manager.” The item return transaction integration manager is implemented as executable instructions programmed and residing within memory and/or a non-transitory computer-readable (processor-readable) storage medium and executed by one or more processors of a device. The processors that execute the item return transaction integration manager are specifically configured and programmed for processing the item return transaction integration manager. The item return transaction integration manager may have access to one or more network connections during its processing. The network connections can be wired, wireless, or a combination of wired and wireless.

In an embodiment, the device that executes the item return transaction integration manager is server 110. In an embodiment, the device that executes the item return transaction integration manager is cloud 110.

In an embodiment, the item return transaction integration manager is all of or some combination of 113-114 and/or method 200 of FIG. 2.

The item return transaction integration manager presents another and, in some ways, enhanced processing perspective of the what was discussed above for cloud 110 and method 200.

At 310, item return transaction integration manager receives a notification of an item return from a workflow being processed by a POS system of a retailer indicating that a consumer is engaged in a transaction to return an item with an item return.

In an embodiment, at 311, the item return transaction integration manager receives location data for a geographical location of a device that initiated the item return with the POS system.

In an embodiment of 311 and at 312, the item return transaction integration manager processes an API call to a web-based weather service to obtain current weather and climate data associated with the geographical location of the device that initiated the item return.

At 320, the item return transaction integration manager obtains item return data for the item return.

At 330, the item return transaction integration manager obtains retailer data maintained by the retailer for the consumer and the item.

At 340, the item return transaction integration manager identifies a manufacturer of the item from the item return data or the retailer data.

At 350, the item return transaction integration manager stores the item return data and the retailer data in an item return data store.

In an embodiment of 312 and 350, at 351, the item return transaction integration manager stores the current weather and climate data with the item return data and the retailer data within the item return data store.

At 360, the item return transaction integration manager obtains a second workflow that is specific to the retailer and the manufacturer.

At 370, the item return transaction integration manager processes the second workflow causing a second notification to be sent to the manufacturer along with the item return data and selective portions of the retailer data based on criteria associated with the second workflow.

In an embodiment, at 380, the item return transaction integration manager provides an interface accessible to the retailer and the manufacturer for accessing the item return data store.

In an embodiment of 380 and at 381, the item return transaction integration manager provides a mining service (mining functions), a querying service (querying functions), and a reporting service (reporting functions) through the interface to the item return data store via returns data service 114.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving notification of an item return being processed on a transaction terminal for an item;
obtaining retailer-specific data, consumer-specific data, item specific data, and item return data from a retailer associated with the item return;
identifying a manufacturer and retailer workflow associated with the retailer and a manufacturer of the item; and
processing the workflow to provide a near real-time alert to the manufacture.

2. The method of claim 1 further comprising:
indexing, linking, and storing the retailer-specific data, the consumer-specific data, the item specific data, and the item return data within an item return data store.

3. The method of claim 2 further comprising:
providing an interface accessible to the manufacturer for querying, mining, and obtaining reports from the item return data store.

4. The method of claim 3, wherein providing further includes providing an Application Programming Interface (API) to the manufacturer for querying, mining, and obtaining reports from the item return data store through API calls issued from automated applications of the manufacturer.

5. The method of claim 1, wherein processing further includes determining from criteria of the manufacturer and retailer workflow whether the manufacturer is permitted to establish direct communications with a consumer associated with the item return.

6. The method of claim 1, wherein processing further includes verifying a survey provided by the manufacturer comports with criteria defined by the retailer within the manufacturer and retailer workflow and when the survey comports with the criteria delivering the survey to a consumer associated with the item return.

7. The method of claim 6, wherein delivering further includes recording responses provided by the consumer to the survey within an item return data store.

8. The method of claim 6, wherein delivering further includes recording responses provided by the consumer to the manufacturer for the survey within an item return data store.

9. The method of claim 1, wherein processing further includes verifying a certificate or a signature associated with a link to a survey that is provided by the manufacturer is valid and when valid sending the link to the consumer.

10. The method of claim 1, wherein processing further includes mining an item return data store comprising the retailer-specific data, the consumer-specific data, other consumer-specific data associated with other consumers that returned the item, the item specific data, the item return data, and other item return data associated other item returns of the item for at least one correlation.

11. The method of claim 10, wherein mining further includes reporting the at least one correlation to the manufacturer and the retailer.

12. The method of claim 1, wherein processing further includes establishing a video conference or voice call between a consumer associated with the item return and a representative of the manufacturer based on the manufacturer and retailer.

13. A method comprising:
receiving a notification of an item return from a workflow of a Point-Of-Sale (POS) system for a retailer indicating that a consumer is engaged in a transaction to return an item with the item return;
obtaining item return data for the item return;
obtaining retailer data maintained by the retailer for the consumer and the item;
identifying a manufacturer of the item from the item return data or the retailer data;
storing the item return data and retailer data in an item return data store;
obtaining a second workflow that is specific to the retailer and the manufacturer;
processing the second workflow causing a second notification to be sent to the manufacturer along with the item return data and selective portions of the retailer data based on criteria associated with the second workflow.

14. The method of claim 13, wherein receiving further includes receiving location data for a geographic location of a device that initiated the item return with the POS system.

15. The method of claim 14, wherein receiving further includes processing an Application Programming Interface (API) call to a web-based weather service to obtain current weather and climate data associated with the geographical location of the device.

16. The method of claim 15, wherein storing further includes storing the current weather and climate data with the item return data and the retailer data within the item return data store.

17. The method of claim 13 further comprising, providing an interface accessible to the retailer and the manufacturer for accessing the item return data store.

18. The method of claim 17, wherein providing further includes providing a mining service, a querying service, and a reporting service through the interface to the item return data store.

19. A system, comprising:
a server comprising a processor and a non-transitory computer-readable storage medium;
the non-transitory computer-readable storage medium comprises executable instructions;
the executable instructions when executed on the processor from the non-transitory computer-readable storage medium cause the processor to perform first operations comprising:
receiving a notification from a Point-Of-Sale (POS) system that an item return for an item was initiated on a device operated by or operated on behalf of a consumer that is returning the item to a retailer associated with the POS system;
obtaining item return data for the item return and retailer specific data for the consumer and the item;
storing the item return data and retailer specific data in an item return data store;
obtaining a workflow associated with a manufacturer of the item and the retailer;
processing the workflow and providing a second notification to the manufacturer for the item return along with the item return data and selective portions of the retailer specific data based on criteria associated with the workflow; and
providing an interface to the retailer and the manufacturer for perform customized mining, querying, and reporting from the item return data store.

20. The system of claim 19, wherein the device that initiated the item return is a mobile device operated by the consumer or a Self-Service Terminal (SST) operated by the consumer within a store of the retailer.
